(19) United States
(12) Patent Application Publication
(10) Pub. No.: US 2016/0082712 A1
(43) Pub. Date: Mar. 24, 2016

(54) LAMINATING APPARATUS AND METHOD OF MANUFACTURING IMAGE RECORDING MEDIUM

(71) Applicant: FUJI XEROX CO., LTD., Tokyo (JP)

(72) Inventors: Naoyuki EGUSA, Kanagawa (JP); Tomoo KOBAYASHI, Kanagawa (JP)

(73) Assignee: FUJI XEROX CO., LTD., Tokyo (JP)

(21) Appl. No.: 14/613,529

(22) Filed: Feb. 4, 2015

(30) Foreign Application Priority Data
Sep. 19, 2014 (JP) 2014-191946

(51) Int. Cl. B32B 38/18

(52) U.S. Cl. CPC B32B 38/18; B32B 2305/00

(57) ABSTRACT

Provided is a laminating apparatus including a peeling unit that peels off a second film from a film material which includes a first film on which an image is formed and the second film coming in close contact with an opposite side to the image of the first film, and a first laminating unit that laminates a base material and the first film from which the second film is peeled off by the peeling unit.

### CROSS-REFERENCE TO RELATED APPLICATIONS

This application is based on and claims priority under 35 USC 119 from Japanese Patent Application No. 2014-191946 filed Sep. 19, 2014.

### BACKGROUND

### Technical Field

The present invention relates to a laminating apparatus and a method of manufacturing an image recording medium.

### SUMMARY

When a film on which an image is formed is laminated on a base material, the film needs to have a sufficient thickness in order to perform an image forming process on the film. For this reason, in order to thinly form the film on which the image is formed with a sufficient thickness to form the image, the film is configured to have a first film and a second film coming in close contact with an opposite side to the first film.

According to an aspect of the invention, there is provided a laminating apparatus including:

a peeling unit that peels off a second film from a film material which includes a first film on which an image is formed and the second film coming in close contact with an opposite side to the image of the first film; and

a first laminating unit that laminates a base material and the first film from which the second film is peeled off by the peeling unit.

### BRIEF DESCRIPTION OF THE DRAWINGS

Exemplary embodiments of the present invention will be described in detail based on the following figures, wherein:

FIG. 1 is an entire configuration diagram that schematically shows a laminating apparatus according to a first exemplary embodiment;

FIG. 2A is a longitudinal cross-sectional view of a film material according to the first exemplary embodiment;

FIG. 2B is a longitudinal cross-sectional view of a second film according to the first exemplary embodiment;

FIG. 2C is a longitudinal cross-sectional view of a first film according to the first exemplary embodiment;

FIG. 2D is a longitudinal cross-sectional view of a base material according to the first exemplary embodiment;

FIG. 2E is a longitudinal cross-sectional view showing a case where the first film is laminated on the base material according to the first exemplary embodiment;

FIG. 3 is an entire configuration diagram that schematically shows a laminating apparatus according to a second exemplary embodiment;

FIG. 4A is a longitudinal cross-sectional view of a film material according to the second exemplary embodiment;

FIG. 4B is a longitudinal cross-sectional view of a base material according to the second exemplary embodiment;

FIG. 4C is a longitudinal cross-sectional view showing a case where the film material according to the second exemplary embodiment is laminated on the base material;

FIG. 4D is a longitudinal cross-sectional view of a second film according to the second exemplary embodiment;

FIG. 4E is a longitudinal cross-sectional view showing a case where the first film is laminated on the base material according to the second exemplary embodiment;

FIG. 4F is a longitudinal cross-sectional view showing a case where the base material and the first film according to the second exemplary embodiment are further pressurized;

FIG. 5A is a longitudinal cross-sectional view of a second film according to a first comparative example;

FIG. 5B is a longitudinal cross-sectional view of a base material according to the first comparative example;

FIG. 5C is a longitudinal cross-sectional view showing a case where the second film is laminated on the base material according to the first comparative example; and

FIG. 6 is an entire configuration diagram of a laminating apparatus according to a second comparative example.

### DETAILED DESCRIPTION

### First Exemplary Embodiment

Examples of a laminating apparatus and a method of manufacturing an image recording medium according to a first exemplary embodiment will be described.

Entire Configuration

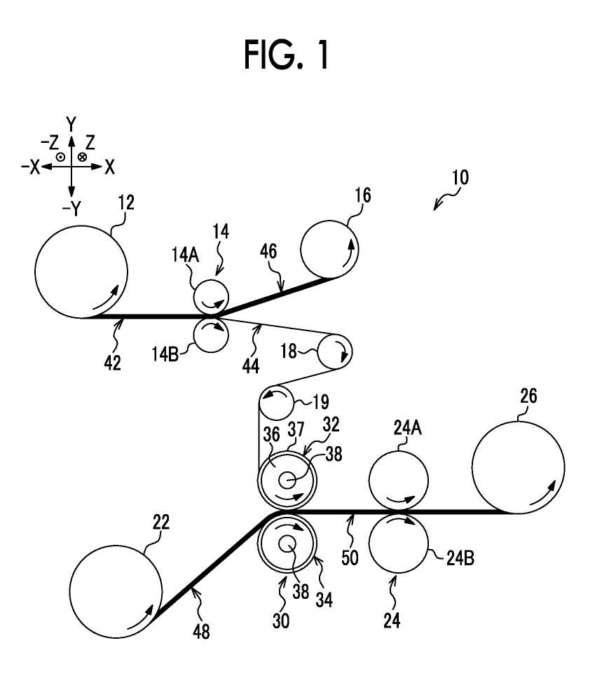

FIG. 1 shows a laminating apparatus 10 according to the first exemplary embodiment. The laminating apparatus 10 includes, for example, a first feed roll 12, a peeling unit 14, a first winding roll 16, guide rolls 18 and 19, a second feed roll 22, a laminating unit 30, a driving roll pair 24, and a second winding roll 26. The peeling unit 14 is an example of a peeling section. The laminating unit 30 is an example of a laminating section.

In the following description, in a front view of the laminating apparatus 10, an apparatus width direction, an apparatus height direction and an apparatus depth direction are respectively described as an X direction, a Y direction and a Z direction. The X direction, the Y direction and the Z direction are perpendicular to one another. When it is necessary to distinguish one side of the X direction, the Y direction or the Z direction from the other side thereof, in the front view of the laminating apparatus 10, an upper side is described as a Y side, a lower side is described as a −Y side, a right side is described as an X side, a left side is described as a −X side, a depth side is described as a Z side, and a front side is described as a −Z side. The term “laminate” means that a target is pressurized or heated, or the target is heated and pressurized.

First Feed Roll

The first feed roll 12 is provided at a non-illustration frame to be rotated with the Z direction as an axial direction. A film material 42 is previously wound around an outer circumference of the first feed roll 12. The film material 42 is drawn from the −Y side of an outer circumferential surface of the first feed roll 12 to the X side. The film material 42 fed from the first feed roll 12 is pulled out due to tension set between the film material and the peeling unit 14 to be described below. The film material 42 will be described below.

Guide Roll

The guide rolls 18 and 19 are made from, for example, stainless steel, and are provided at the non-illustration frame to be rotated with the Z direction as an axial direction. The guide rolls 18 and 19 are located on the X side and the −Y side with respect to the peeling unit 14 to be described below. A first film 44 peeled off by the peeling unit 14 is wound around the guide rolls 18 and 19 in an S shape. The first film 44 wound around the guide roll 19 is pulled out due to tension set between the first film and the laminating unit 30 to be described below.

Second Feed Roll

The second feed roll 22 is provided at the non-illustration frame on the −Y side of the first feed roll 12 to be rotated with the Z direction as an axial direction. A base material 48 is previously wound around an outer circumference of the second feed roll 22. The base material 48 is drawn from the −Y side of the outer circumferential surface of the second feed roll 22 toward the laminating unit 30 to be described below. The base material 48 drawn from the second feed roll 22 is pulled out due to tension set between the base material and the laminating unit 30 to be described below. The base material 48 will be described below.

Driving Roll Pair

The driving roll pair 24 includes, for example, two rolls 24A and 24B which are provided at the non-illustration frame to be rotated with the Z direction as an axial direction by a non-illustration driving source and are made from stainless steel. The driving roll pair 24 is located on the X side with respect to the laminating unit 30 to be described below. The roll 24A and the roll 24B interpose the first film 44 and the base material 48 therebetween. The first film 44 and the base material 48 interposed between the driving roll pair 24 are pulled out due to tension set between the first film and base material and the laminating unit 30 to be described below and tension set between the first film and base material and the second winding roll 26 to be described below.

Second Winding Roll

The second winding roll 26 is provided at the non-illustration frame to be rotated with the Z direction as an axial direction by the non-illustration driving source. The second winding roll 26 is located on the X side with respect to the driving roll pair 24, and is configured to wind the first film 44 and the base material 48 pressurized by the driving roll pair 24.

Film Material

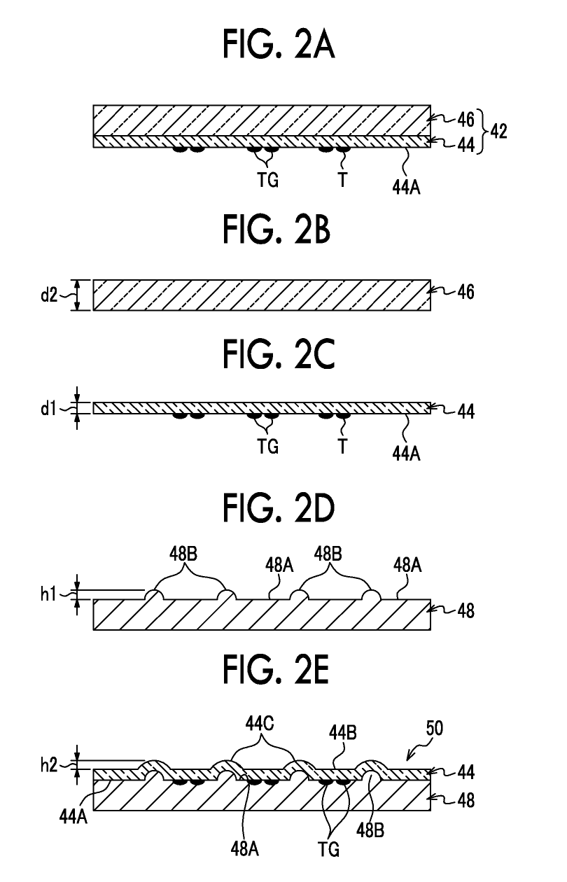

As shown in FIG. 2A, the film material 42 includes the first film 44 on which a toner image TG is formed as an example of an image, and a second film 46 coming in close contact with a side opposite to a side of the first film 44 on which the toner image TG is formed. A thickness of the film material 42 is set to, for example, 50 [μm] or more and 350 [μm] or less. A non-illustration adhesive layer or bonding layer is formed between the first film 44 and the second film 46.

The adhesive layer and the bonding layer indicate a layer having a function as an adhesive that physically connects the first film 44 and the second film 46 and a releasing function of releasing the second film 46 from the first film 44. As the adhesive layer, a layer, which is made from a semi-solid material under a normal temperature and pressure (for example, 22[° C.] and atmospheric pressure) and may bond other layers without being changed in state after bonding and allowing the adhesive layer itself to be solidified, is used. As the bonding layer, a layer which is made from a solid material under a normal temperature and pressure is used.

First Film

The first film 44 shown in FIG. 2C includes, for example, a transparent polyethylene-telephthalate film. A thickness d1 of the first film 44 is set to, for example, 1 [μm] or more and 50 [μm] or less. As stated above, since the first film 44 is thin, it is difficult to form an image in an electrophotographic type image forming apparatus by using only the first film.

In a stage before the film material 42 is wound around the first feed roll 12, the toner image TG is formed on a lower surface 44A opposite to a side of the first film 44 close to the second film 46 by a non-illustration electrophotographic type image forming apparatus. When the toner image TG is transferred to the base material 48 to be described below, the toner image becomes a reversed image (mirror image) such that the image on the base material 48 becomes a non-reversed image (normal image). An adhesive layer to which toner T adheres and which comes in close contact with the base material 48 is formed on the lower surface 44A.

Second Film

The second film 46 shown in FIG. 2B is formed using, for example, a polyethylene-telephthalate film. A thickness 2d of the second film 46 is thicker than the thickness d1 of the first film 44 (see FIG. 2C), and is set to, for example, 50 [μm] or more and 300 [μm] or less. As mentioned above, since the second film 46 is thick, it is possible to form an image by the electrophotographic type image forming apparatus by using only the second film.

Base Material

As shown in FIG. 2D, the base material 48 is formed using, for example, cloth whose surface has plural concave portions 48A and plural convex portions 48B. In FIGS. 2D and 2E, fiber of the base material 48 is not shown, and the concave and convex portions are schematically shown. For example, a thickness of the base material 48 is thicker than the thickness of the second film 46 (see FIG. 2B). It is assumed that an average height of the convex portions 48B with respect to the surface of the base material 48 is an unevenness amount h1.

Configuration of Major Components

Next, a configuration of major components of the laminating apparatus 10 will be described.

Peeling Unit

As shown in FIG. 1, the peeling unit 14 includes, for example, the first winding roll 16, and two rolls 14A and 14B which are provided at the non-illustration frame to be rotated with the Z direction as an axial direction and are made from stainless steel. The peeling unit 14 is located on the X side with respect to the first feed roll 12. The roll 14A and the roll 14B interpose the film material 42 therebetween.

First Winding Roll

The first winding roll 16 is provided at the non-illustration frame to be rotated with the Z direction as an axial direction by the non-illustration driving source. The first winding roll 16 is located on the X side and the Y side with respect to the roll 14A and the roll 14B, and is configured to wind the second film 46 passing between the roll 14A and the roll 14B.

The second film 46 is wound around a part of an outer circumferential surface of the roll 14A, and is pulled out toward the first winding roll 16. The first film 44 is wound around a part of an outer circumferential surface of the roll 14B, and is pulled out toward the guide roll 18. Thus, the first film 44 and the second film 46 of the film material 42 are peeled off from each other in the peeling unit 14.

Laminating Unit

The laminating unit 30 includes, for example, a pair of laminating rolls 32 and 34. The laminating rolls 32 and 34 are provided at the non-illustration frame to be rotated with the Z direction as an axial direction, the laminating roll 32 is disposed on the Y side, and the laminating roll 34 is disposed on the −Y side. The first film 44 is previously wound around a part of an outer circumferential surface of the laminating roll 32, and the base material 48 is previously wound around a part of an outer circumferential surface of the laminating roll 34.

The base material 48 and the first film 44 are interposed between the outer circumferential surface of the laminating roll 32 and the outer circumferential surface of the laminating roll 34, and are pressurized. For example, since the laminating roll 32 and the laminating roll 34 have the same configuration as a single member, the laminating roll 32 will be described, and the laminating roll 34 will not be described.

The laminating roll 32 includes, for example, a cylindrical core bar 36 made from stainless steel, an elastic material 37 which is made from rubber and is formed on an outer circumferential surface of the core bar 36, and a heating unit 38 disposed inside the core bar 36. The heating unit 38 includes, for example, a ceramic heater that generates heat by applying electricity. Temperatures of the outer circumferential surfaces of the laminating rolls 32 and 34 are measured by non-illustration temperature sensors. The electricity applied to the heating unit 38 is turned on when the temperatures measured by the non-illustration temperature sensors are equal to or lower than a set temperature, and is turned off when the measured temperatures are greater than the set temperature.

### First Comparative Example

Next, a laminated member 200 according to a first comparative example will be described.

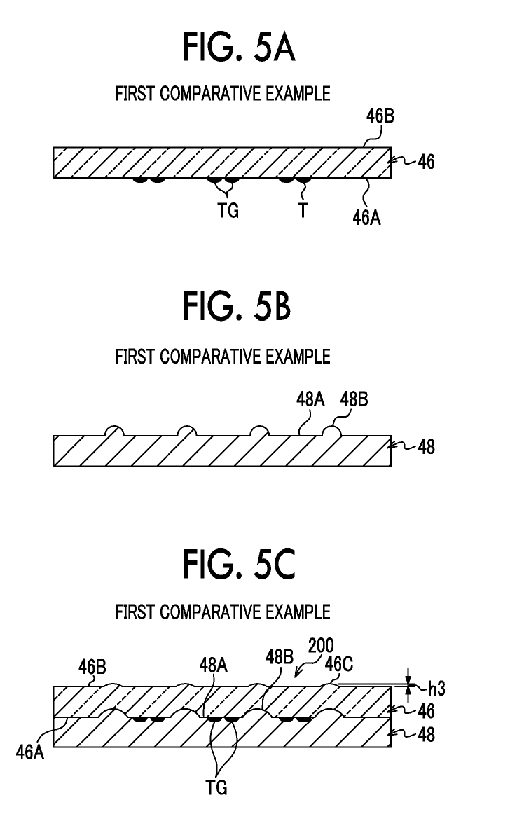

As shown in FIG. 5A, in the first comparative example, the toner image TG is formed on a lower surface 46A on one side of the second film 46 in a thickness direction by using the non-illustration electrophotographic type image forming apparatus. As shown in FIG. 5B, in the first comparative example, the base material 48 is used. As shown in FIG. 5C, in the first comparative example, the second film 46 on which the toner image TG is formed is directly laminated on the base material 48 by the laminating unit 30 (see FIG. 1). Thus, the laminated member 200 according to the first comparative example in which the lower surface 46A and the concave portions 48A and the convex portions 48B of the base material 48 come in contact with each other is formed.

Here, the thickness of the second film 46 shown in FIG. 5C is thicker than that of the first film 44 (see FIG. 2C). For this reason, in the laminated member 200 according to the first comparative example, the second film 46 is deformed in the vicinity of the convex portions 48B of the base material 48, but an unevenness amount h3 appearing on a surface 46B of the second film 46 in the thickness direction becomes smaller than the unevenness amount h1 of the base material 48 (see FIG. 2D). The unevenness amount h3 corresponds to a height of a protrusion 46C protruding from the surface 46B.

Operation

Next, an operation of the first exemplary embodiment will be described.

Preparation Process

As shown in FIG. 2A, the toner image TG is formed on the lower surface 44A of the first film 44 of the film material 42 by using the non-illustration electrophotographic type image forming apparatus (image forming process). That is, the toner image TG is fixed on the first film 44.

The film material 42 on which the toner image TG is fixed is wound around the first feed roll 12 shown in FIG. 1 by using a non-illustration winding machine. Here, deformation (occurrence of wrinkles, for example) of the first film 44 is suppressed by the second film 46 thicker than the first film 44 until the second film 46 is peeled off by the peeling unit 14. One end of the film material 42 is fed from the first feed roll 12, and passes between the roll 14A and the roll 14B. Thus, the first film 44 and the second film 46 are peeled off from each other.

One end of the peeled-off first film 44 is wound around the guide rolls 18 and 19, passes between the laminating roll 32 and the laminating roll 34, passes between the driving roll pair 24, and is attached to the outer circumferential surface of the second winding roll 26. Meanwhile, one end of the peeled-off second film 46 is attached to the outer circumferential surface of the first winding roll 16. One end of the base material 48 wound around the second feed roll 22 passes together with the first film 44 between the laminating roll 32 and the laminating roll 34, passes between the driving roll pair 24, and is attached to the outer circumferential surface of the second winding roll 26.

The concave portion 48A and the convex portion 48B of the base material 48 (see FIG. 2D) come in contact with the lower surface 44A of the first film 44 (see FIG. 2C). End surfaces of the first film 44, the second film 46 and the base material 48 on both sides in the Z direction are aligned.

Laminating Process

In the laminating apparatus 10 shown in FIG. 1, the laminating roll 32 and the laminating roll 34 are heated by the heating unit 38. The first winding roll 16 and the second winding roll 26 are driven to be rotated, and, thus, the film material 42 is fed from the first feed roll 12.

The second film 46 of the drawn film material 42 is peeled off from the first film 44 in the peeling unit 14 (an example of a peeling process). The second film 46 is wound around the first winding roll 16. Meanwhile, the first film 44 is fed to the laminating unit 30 through the guide rolls 18 and 19, and is overlapped with the base material 48 fed to the laminating unit 30 such that the toner image TG side of the first film 44 (see FIG. 2C) comes in contact with the base material 48.

In the laminating unit 30, the non-illustration adhesive layer of the first film 44 is pressed and fixed to the base material 48 by being pressurized by the laminating rolls 32 and 34 and heated by the heating unit 38, and, thus, a laminated member 50 (see FIG. 2E) is formed (an example of the laminating process). The laminated member 50 is wound around the second winding roll 26 while being cooled by thermally conducting the roll 24A and the roll 24B. The laminated member 50 wound around the second winding roll 26 is cut out for each image by a non-illustration cutting machine. The laminated member 50 is an example of an image recording medium.

Here, as shown in FIG. 2E, in the laminated member 50, the first film 44 thinner than the second film 46 (see FIG. 2B) comes in close contact with the base material 48. For this reason, compared to the case where the thick second film 46 comes in close contact with the base material 48, a concave-convex shape of the surface of the first film 44 approximates to a concave-convex shape of the base material 48. That is, an unevenness amount h2 which is a height of a convex portion 44C appearing on a surface 44B of the first film 44 approximates to the unevenness amount h1 of the base material 48 (see FIG. 2D). Thus, a reduction in the unevenness amount h1 of the base material 48 (appearing on the surface of the first film 44 on which the image is formed) seen in the laminated member 50 is suppressed.

### Second Exemplary Embodiment

Next, examples of a laminating apparatus and a method of manufacturing an image recording medium according to a second exemplary embodiment will be described. The components and portions which are basically the same as those in the first exemplary embodiment will be assigned the same reference numerals as those in the first exemplary embodiment, and the description thereof will not be presented.

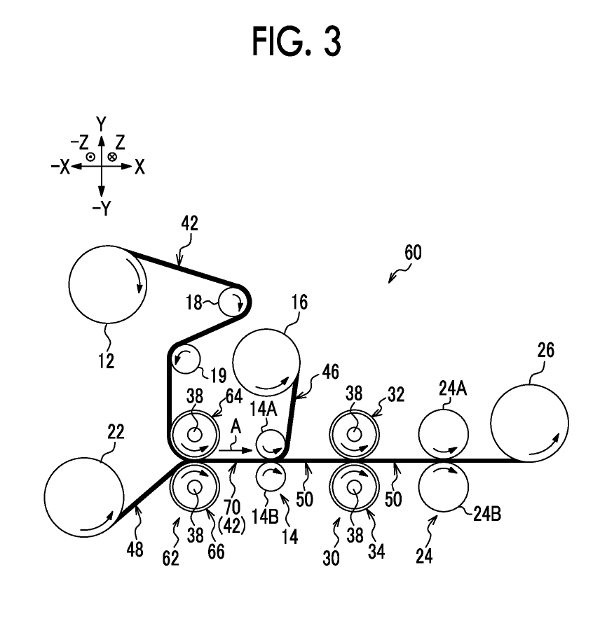

FIG. 3 shows a laminating apparatus 60 according to the second exemplary embodiment. The laminating apparatus 60 has a difference from the laminating apparatus 10 according to the first exemplary embodiment (see FIG. 1) in that an upstream laminating unit 62 as an example of another laminating section is provided on a front side (upstream side) rather than the peeling unit 14 in a transport direction of the film material 42 (indicated by arrow A).

The laminating apparatus 60 includes the first feed roll 12, the guide rolls 18 and 19, the upstream laminating unit 62, the peeling unit 14, the laminating unit 30, the driving roll pair 24, and the second winding roll 26 in order from an upstream side toward a downstream side in the transport direction of the film material 42. The laminating apparatus 60 further includes the second feed roll 22 that supplies the base material 48 to the upstream laminating unit 62.

Upstream Laminating Unit

The upstream laminating unit 62 includes, for example, a pair of laminating rolls 64 and 66. For example, the laminating rolls 64 and 66 have the same configurations as those of the laminating rolls 32 and 34 according to the first exemplary embodiment (see FIG. 1), but a set temperature of the heating unit 38 is higher than set temperatures of the laminating rolls 32 and 34. The laminating rolls 64 and 66 pressurize the base material 48 and the film material 42 while interposing the base material and the film material between an outer circumferential surface of the laminating roll 64 disposed on the Y side and an outer circumferential surface of the laminating roll 66 disposed on the −Y side.

Temperatures of the outer circumferential surfaces of the laminating rolls 64 and 66 are measured by a non-illustration temperature sensor. The electricity applied to the heating unit 38 is turned on when the temperatures measured by the non-illustration temperature sensor are equal to or lower than the set temperature, and is turned off when the measured temperatures are greater than the set temperature.

### Second Comparative Example

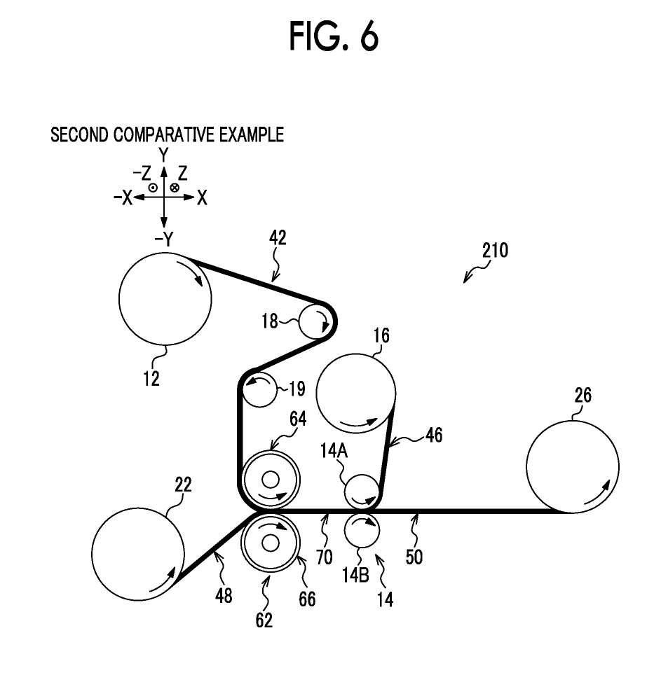

FIG. 6 shows a laminating apparatus 210 according to a second comparative example. The laminating apparatus 210 has a configuration in which the laminating unit 30 and the driving roll pair 24 are excluded from the laminating apparatus 60 according to the second exemplary embodiment. In the laminating apparatus 210, the film material 42 is laminated on the base material 48 by the upstream laminating unit 62, and a laminated member 70 is formed. In the peeling unit 14, the second film 46 is peeled off from the laminated member 70, and the laminated member 50 is formed.

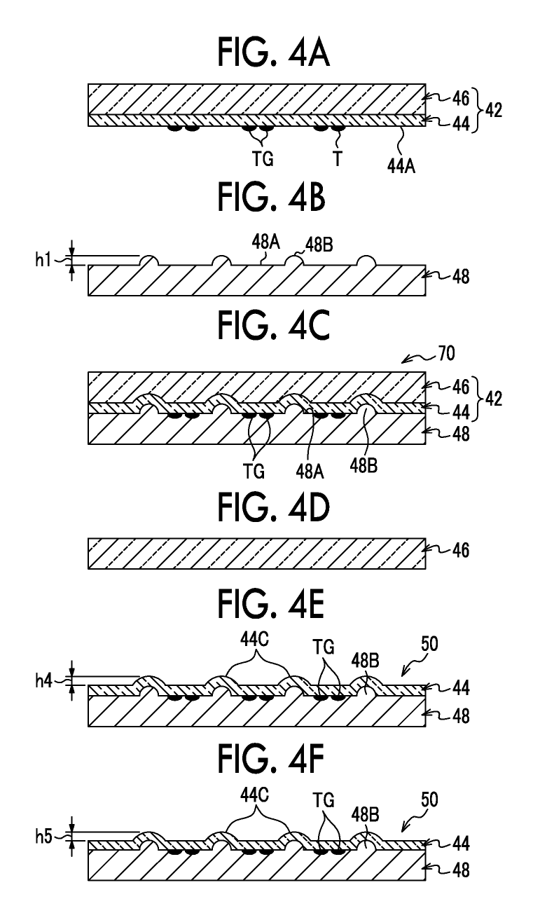

Here, when the film material 42 is laminated on the base material 48 by the upstream laminating unit 62, since the thickness of the second film 46 and the thickness of the base material 48 are thicker than that of the first film 44 as shown in FIG. 4C, it is difficult to transfer heat to the first film 44. For this reason, it is difficult to form the first film 44 into a shape corresponding to the shapes of the concave portions 48A and the convex portions 48B of the base material 48. In this state, when the second film 46 is peeled off by the peeling unit 14 (see FIG. 6), an unevenness amount h4 of the convex portion 44C of the first film 44 shown in FIG. 4E is more reduced than the unevenness amount h1 of the base material 48 (see FIG. 2D). That is, in the laminating apparatus 210 according to the second comparative example shown in FIG. 6, the unevenness amount of the laminated member 50 after the second film. 46 is peeled off by the peeling unit 14 is reduced.

Operation

Next, an operation of the second exemplary embodiment will be described.

Preparation Process

As shown in FIG. 4A, the toner image TG is formed on the lower surface 44A of the first film 44 of the film material 42 by using the non-illustration electrophotographic type image forming apparatus (image forming process). The toner image TG is fixed on the first film 44, and is prevented from being peeled off from the first film 44.

The film material 42 on which the toner image TG is fixed is wound around the first feed roll 12 by using the non-illustration winding machine. One end of the film material 42 is drawn from the first feed roll 12, is wound around the guide rolls 18 and 19, and passes between the laminating rolls 64 and 66 and between the rolls 14A and 14B. Thus, the first film 44 and the second film 46 are peeled off from each other.

One end of the peeled-off first film 44 passes between the laminating roll 32 and the laminating roll 34, passes between the driving roll pair 24, and is attached to the outer circumferential surface of the second winding roll 26. Meanwhile, one end of the peeled-off second film 46 is attached to the outer circumferential surface of the first winding roll 16. One end of the base material 48 wound around the second feed roll 22 together with the film material 42 passes between the laminating rolls 64 and 66, passes the peeling unit 14, the laminating unit 30 and the driving roll pair 24, and is attached to the outer circumferential surface of the second winding roll 26.

A surface on which the concave portions 48A and the convex portions 48B of the base material 48 (see FIG. 4B) are formed comes in contact with the lower surface 44A of the first film 44 (see FIG. 4C). Widths of the first film. 44, the second film 46 and the base material 48 in the Z direction are equal to each other, and end surfaces on both sides in the Z direction are aligned.

Laminating Process

In the laminating apparatus 60 shown in FIG. 3, the laminating rolls 32, 34, 64 and 66 are heated by the heating unit 38. The first winding roll 16 and the second winding roll 26 are driven to be rotated, and, thus, the film material 42 is drawn from the first feed roll 12.

The film material 42 is transported to the upstream laminating unit 62 through the guide rolls 18 and 19, and is overlapped with the base material 48 fed to the upstream laminating unit 62 such that the toner image TG side of the first film 44 (see FIG. 4C) comes in contact with the base material 48.

In the upstream laminating unit 62, the film material 42 is pressed and fixed on the base material 48 by being pressurized by the laminating rolls 64 and 66 and heated by the heating unit 38, and the laminated member 70 (see FIG. 4C) is formed (another example of the laminating process). Subsequently, the laminated member 70 becomes the laminated member 50 by peeling off the second film. 46 from the first film 44 by the peeling unit 14 (an example of the peeling process). The second film 46 (see FIG. 4D) is wound around the first winding roll 16.

Here, since the first film 44 is heated in the upstream laminating unit 62 through the second film 46, a heat amount applied to the first film 44 is smaller than that in the case where the first film 44 is directly heated. For this reason, as shown in FIG. 4E, the first film 44 comes in close contact with the base material 48, but the unevenness amount h4 of the convex portion 44C is the same as that in the case where the laminating is performed in the laminating apparatus 210 according to the second comparative example (see FIG. 6).

Thereafter, in the laminating unit 30, the first film (see FIG. 4F) is further pressed and fixed on the base material 48 by being pressurized by the laminating rolls 32 and 34 and heated by the heating unit 38 (an example of the laminating process). The laminated member 50 is pressurized and cooled by being interposed between the roll 24A and the roll 24B, and is wound around the second winding roll 26. The laminated member 50 wound around the second winding roll 26 is cut out for each image by the non-illustration cutting machine.

As shown in FIGS. 4E and 4F, in the stage before the laminated member 50 is heated and pressurized in the laminating unit 30 (see FIG. 3), the unevenness amount is h4. However, after the laminated member is heated and pressurized in the laminating unit 30, the unevenness amount is h5 (>h4). That is, the unevenness amount h5 of the first film 44 approximates to the unevenness amount h1 of the base material 48 (see FIG. 4B). Thus, a reduction in the unevenness amount h1 of the base material 48 (appearing on the surface of the first film 44 on which the image is formed) seen in the laminated member 50 is suppressed.

As mentioned above, in the laminating apparatus 60 according to the second exemplary embodiment shown in FIG. 3, the film material 42 and the base material 48 are heated and pressurized by the upstream laminating unit 62 before the peeling process by the peeling unit 14. Thus, adhesivity of the first film 44 to the base material 48 is improved. Fixability of the toner image TG on the base material 48 is improved.

The present invention is not limited to the aforementioned exemplary embodiments.

The peeling unit 14 may be provided with an air jetting nozzle that sprays air between the first film 44 and the second film 46 to peel off the first film from the second film. When it is not necessary to pressurize and cool the laminated member 50 after being heated and pressurized by the laminating unit 30, the driving roll pair 24 may not be provided.

The laminating section is not limited to the laminating unit 30, and various laminating techniques that are known in the related art may be used. For example, a thermal fusion technique performed by allowing the first film 44 and the base material 48 to pass through a nip portion of a belt pair and thermally melting the first film and the base material to some extent may be used, or a thermal press device may be used.

The first film 44 may be a film in which an image receiving layer is formed on a surface on which the toner image TG is formed. The image receiving layer may be made from thermoplastic resin, and when the image receiving layer includes, for example, the same resin as resin contained in the toner T, fixability of the toner image TG on the base material 48 is improved. In order to increase film strength, the image receiving layer may include curable resin such as thermosetting resin, photo curable resin and electron beam curable resin. The image receiving layer may include a releasing agent such as natural wax, synthetic wax, releasing resin, a reactive silicone compound, and modified silicone oil.

The first film 44 may have a thickness thicker than that of the second film 46.

The film material 42 and the base material 48 are not limited to a continuous sheet type, and may be a single sheet type. In the single sheet type, the first film 44 and the second film 46 may be previously peeled off from each other at a front end of the film material 42 in the transport direction, and the first film 44 and the second film 46 may be adsorbed by separate adsorbing rolls and peeled off from each other. As the adsorbing roll, a roll that performs adsorption using static electricity or a roll that performs adsorption through air suction may be used.

In the laminating apparatuses 10 and 60, a cutter may be provided instead of the second winding roll 26, and the transported laminated member 50 may be cut to be accumulated without being wound. The laminating apparatus performs heating and pressurizing, but is not limited thereto. The laminating apparatus may perform only heating, or may perform only pressurizing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A laminating apparatus comprising:
a peeling unit that peels off a second film from a film material which includes a first film on which an image is formed and the second film coming in close contact with an opposite side to the image of the first film; and
a first laminating unit that laminates a base material and the first film from which the second film is peeled off by the peeling unit.

2. The laminating apparatus according to claim 1, further comprising:
a second laminating unit that laminates the film material and the base material before the second film is peeled off by the peeling unit.

3. A method of manufacturing an image recording medium, the method comprising:
peeling off a second film from a film material which includes a first film on which an image is formed and the second film coming in close contact with an opposite side to the image of the first film; and
laminating a base material and the first film from which the second film is peeled off.

4. The laminating apparatus according to claim 1, wherein
the first film is a film in which an image receiving layer is formed.

5. The method of manufacturing an image recording medium according to claim 3, wherein
the first film is a film in which an image receiving layer is formed.
